(19) United States
(12) Patent Application Publication
(10) Pub. No.: US 2024/0262692 A1
(43) Pub. Date: Aug. 8, 2024

(54) NEGATIVE ELECTRODE MATERIAL, PREPARATION METHOD THEREFOR AND APPLICATION THEREOF, AND NEGATIVE ELECTRODE PLATE AND APPLICATION

(71) Applicant: NATIONAL INSTITUTE OF CLEAN-AND-LOW-CARBON ENERGY, Beijing (CN)

(72) Inventors: Guanghong PAN, Beijing (CN); Zhijiang SU, Beijing (CN); Wenbin LIANG, Beijing (CN); Chang WEI, Beijing (CN); Quanbin CHEN, Beijing (CN)

(73) Assignee: NATIONAL INSTITUTE OF CLEAN-AND-LOW-CARBON ENERGY, Beijing (CN)

(21) Appl. No.: 18/567,001

(22) PCT Filed: Nov. 29, 2021
(86) PCT No.: PCT/CN2021/133972

§ 371 Date: Dec. 4, 2023

(30) Foreign Application Priority Data
Jun. 10, 2021 (CN) 202110648445.0

(51) Int. Cl. C01B 32/23; H01M 4/02; H01M 10/0525

(52) U.S. Cl. CPC C01B 32/23; H01M 10/0525; C01P 2002/02; C01P 2002/72; C01P 2002/82; C01P 2004/84; C01P 2006/12; C01P 2006/14; C01P 2006/16; H01M 2004/021; H01M 2004/027

(57) ABSTRACT

The present invention relates to the field of carbon materials, and discloses a negative electrode material, a preparation method and application thereof, and a negative electrode plate and application thereof. The negative electrode material has the following features: (1) a total pore volume of the negative electrode material is less than or equal to 0.02 cm³/g, and a volume of mesopores having a pore diameter of 2 nm to 50 nm is 0.0001 cm³/g to 0.02 cm³/g; and (2) a height ratio of a D peak to a G peak, obtained by Raman spectroscopy, of the negative electrode material meets the following condition: 0.20≤ID/IG≤1. The negative electrode material has high structural compactness and small crystal particle size, so that a battery containing the negative electrode material not only has high charge-discharge capacity, high initial coulombic efficiency and excellent rate capability, but also has excellent continuous high-rate cycle performance, and the preparation method is simple in process and low in cost.

### CROSS-REFERENCE TO RELATED APPLICATIONS

This application claims the benefit of Chinese Patent Application 202110648445.0 filed on Jun. 10, 2021, the disclosure of which is incorporated herein by reference.

### TECHNICAL FIELD

The present invention relates to the field of carbon materials, and particularly relates to a negative electrode material, a preparation method and application thereof, and a negative electrode plate and application.

### BACKGROUND

A negative electrode of a lithium ion battery is mainly a carbon material, including amorphous carbon, natural graphite, and artificial graphite. Graphite has a regular layered structure and excellent electrical conductivity, has a theoretical specific capacity of 372 mA h/g, is high in efficiency, and is a mainstream negative electrode material at present. At present, raw materials for developing the artificial graphite mainly include three types: isotropic coke, bituminous adhesive and needle coke. The isotropic coke-based artificial graphite is low in crystallinity, high in isotropy, low in capacity and high in power. The needle coke-based artificial graphite is high in capacity, but relatively poor in rate capability, and the bituminous adhesive is generally between the two.

CN104681786A discloses a coal-based negative electrode material. The coal-based negative electrode material is composed of a coal-based material graphitized inner layer, an intermediate layer, and an outer layer distributed on a surface. A preparation method of the material includes: crushing the coal-based material; adding a binder, or a mixer of a binder and a modifier; and then performing compression and high-temperature graphitization to obtain a finished product.

CN111232970A discloses a graphite negative electrode material, a lithium ion battery, a preparation method and application. The preparation method includes the following step of: performing graphitization high-temperature treatment on a mixture of mesocarbon microsphere green pellets, pulverized anthracite and catalyst; wherein a mass ratio of the mesocarbon microsphere green pellets to the pulverized anthracite is 1:9 to 8:1; and a particle size D₅₀ of the pulverized anthracite ranges from 10 μm to 20 μm.

CN111628146A discloses a process for preparing a lithium ion battery negative electrode material by filling microcrystalline graphite with asphalt, which uses the microcrystalline graphite as raw material, and adds medium-low temperature coal tar for kneading to obtain modified microcrystalline graphite; transfers the modified microcrystalline graphite into a reactor, adds liquid-state medium-temperature asphalt, mixes, heats to 350° C. to 500° C., vacuumizes, stands for 1 hour to 3 hours, introduces inert gas, pressurizes, stands for 2 hours to 5 hours, and relieves pressure to obtain asphalt-filled microcrystalline graphite; and then carries out flaking, powdering, carbonization, screening and demagnetization on the asphalt-filled microcrystalline graphite to obtain a target product.

The negative electrode material provided by the prior art is complex in structure and process and high in cost. Although the prepared negative electrode material can provide higher battery capacity and initial coulombic efficiency, a continuous high-rate cycle performance of the battery is insufficient, which cannot meet actual market demands.

### SUMMARY

In order to overcome the problems of complex structure, poor continuous high-rate cycle performance, complex preparation process and high cost of a negative electrode material in the prior art, the present invention provides a negative electrode material, a preparation method and application thereof. The structure of the negative electrode material has high compactness and the crystal particle sizes of the material are mall, so that the negative electrode material not only has high charge-discharge capacity, high initial coulombic efficiency and excellent rate capability, but also has excellent continuous high-rate cycle performance, and the preparation method is simple in process and low in cost.

In order to achieve the above objects, a first aspect of the present invention provides a negative electrode material, wherein the negative electrode material has the following features:
(1) a total pore volume of the negative electrode material is less than or equal to 0.02 cm³/g, and a volume of mesopores having a pore diameter of 2 nm to 50 nm is 0.00001 cm³/g to 0.02 cm³/g; and
(2) a height ratio of a D peak to a G peak, obtained by Raman spectroscopy, of the negative electrode material meets the following condition: 0.20≤ID/IG≤1.

A second aspect of the present invention provides a preparation method of a negative electrode material, wherein the method includes the following steps of:
(1) crushing coal to obtain coal particles;
(2) graphitizing the coal particles to obtain a graphitized material;
(3) mixing the graphitized material with a modifier to obtain a mixed material;
(4) pre-oxidizing the mixed material in air atmosphere to obtain a pre-oxidized sample; and
(5) carbonizing the pre-oxidized sample in an inert atmosphere to obtain the negative electrode material.

A third aspect of the present invention provides a negative electrode material prepared by the method above.

A fourth aspect of the present invention further provides an application of the above-mentioned coal-based negative electrode material in a lithium ion battery.

According to the above technical solutions, the negative electrode material and the preparation method and application thereof provided by the present invention have the following beneficial effects:
(1) The negative electrode material provided by the present invention has compact structure and small crystal particle size, and a battery containing the negative electrode material has excellent continuous high-rate cycle performance.
(2) The battery containing the negative electrode material provided by the present invention not only has excellent charge-discharge capacity, and initial coulombic efficiency, but also has excellent continuous high-rate cycle performance. Specifically, the charge-discharge capacity of the negative electrode material of the present invention is greater than or equal to 330 mAh/g, the initial coulombic efficiency is greater than or equal to 92%, the rate capability is excellent, and a capacity retention rate of continuous high-rate cycling for 1,500 times at 5 C is greater than or equal to 80%.
(3) In the method for preparing the negative electrode material provided by the present invention, the coal particles are subjected to graphitizing, mixing with the modifier, pre-oxidizing and carbonizing in sequence, so that the structural compactness of the prepared negative electrode material can be significantly improved, and the obtained negative electrode material has small crystal particle size, lithium ions can be intercalated and desorbed in many channels with rapid diffusion, thereby significantly improving the continuous high-rate cycle performance of the negative electrode material.
(4) The negative electrode plate containing the negative electrode material provided by the present invention has a low OI value. Specifically, when the compaction density of the negative electrode plate is 1.4 g/cm³ to 1.6 g/cm³, the OI of the negative electrode plate is less than or equal to 15, indicating that the negative electrode plate has excellent orientation and high isotropy, so that a battery containing the negative electrode plate has excellent rate capability and continuous high-rate cycle performance.

### DESCRIPTION OF EXEMPLARY EMBODIMENTS

The endpoints and any values of the ranges disclosed herein are not limited to the precise ranges or values, which should be understood to include values close to those ranges or values. For numerical ranges, one or more new numerical ranges can be obtained by combining the endpoint values of various ranges, endpoint values of various ranges and individual point values, and individual point values, and these numerical ranges should be regarded as specifically disclosed herein.

A first aspect of the present invention provides a negative electrode material, wherein the negative electrode material has the following features:
(1) a total pore volume of the negative electrode material is less than or equal to 0.02 cm³/g, and a volume of mesopores having a pore diameter of 2 nm to 50 nm is 0.00001 cm³/g to 0.02 cm³/g; and
(2) a height ratio of a D peak to a G peak, obtained by Raman spectroscopy, of the negative electrode material meets the following condition: 0.20≤ID/IG≤1.

In the present invention, the negative electrode material meeting the above conditions has fewer holes, and the negative electrode material has compact structure, fewer defects and small crystal particle size, so that the continuous high-rate cycle performance can be significantly improved on the premise of maintaining high charge-discharge capacity, initial coulombic efficiency and rate capability.

In the present invention, the total pore volume of the negative electrode material and the volume of the mesopores having the pore diameter of 2 nm to 50 nm are measured by a nitrogen adsorption specific surface area method.

Further, when the total pore volume of the negative electrode material is 0.0001 cm³/g to 0.01 cm³/g, and the volume of the mesopores having the pore diameter of 2 nm to 50 nm is 0.00001 cm³/g to 0.01 cm³/g, a lithium ion battery using the negative electrode material as a negative electrode has high charge-discharge capacity, initial coulombic efficiency and rate capability, and has excellent continuous high-rate cycle performance.

Further, when the total pore volume of the negative electrode material is 0.0002 cm³/g to 0.007 cm³/g, and the volume of the mesopores having the pore diameter of 2 nm to 50 nm is 0.0001 cm³/g to 0.007 cm³/g, the lithium ion battery using the negative electrode material as the negative electrode has high charge-discharge capacity, initial coulombic efficiency and rate capability, and has excellent continuous high-rate cycle performance.

Further, when the height ratio of the D peak to the G peak, obtained by Raman spectroscopy, of the negative electrode material meets the following condition: 0.25≤ID/IG≤0.9, preferably 0.30≤ID/IG≤0.8, the lithium ion battery using the negative electrode material as the negative electrode has high charge-discharge capacity and initial coulombic efficiency, and has excellent continuous high-rate cycle performance.

According to the present invention, interplanar spacing d₀₀₂ of a (002) crystal plane, which is obtained by powder XRD, of the negative electrode material meets the following condition: 0.3340 nm≤d₀₀₂≤0.3400 nm.

According to the present invention, a crystal size L_{c} in a c-axis direction, obtained by powder XRD, of the negative electrode material, meets the following condition: 25 nm≤L_{c}≤70 nm.

According to the present invention, a crystal size Lₐ in an a-axis direction, obtained by XRD, of the negative electrode material, meets the following condition: 40 nm≤Lₐ≤150 nm.

In the present invention, the interplanar spacing d₀₀₂ of the (002) crystal plane, the crystal size L_{c} in the c-axis direction and the crystal size Lₐ in the a-axis direction of the negative electrode material are obtained by powder XRD testing of the negative electrode material.

In the present invention, when the interplanar spacing d₀₀₂ of the (002) crystal plane, the crystal size L_{c} in the c-axis direction and the crystal size Lₐ in the a-axis direction of the negative electrode material meet the above conditions, the negative electrode material has the characteristics of small crystal particle size, lithium ions can be intercalated and desorbed in many channels with short paths, and the rate capability of a battery including the negative electrode material can be significantly improved.

Further, the interplanar spacing d₀₀₂ of the (002) crystal plane, which is obtained by powder XRD, of the negative electrode material meets the following condition: 0.3350 nm≤d₀₀₂≤0.3390 nm, preferably, 0.3364 nm≤d₀₀₂≤0.3370 nm.

According to the present invention, the crystal size L_{c} in the c-axis direction, obtained by powder XRD, of the negative electrode material, meets the following condition: 28 nm≤L_{c}≤60 nm, preferably, 30 nm≤L_{c}≤50 nm.

According to the present invention, the crystal size Lₐ in the a-axis direction, obtained by XRD, of the negative electrode material, meets the following condition: 45 nm≤Lₐ≤120 nm, preferably, 50 nm≤Lₐ≤100 nm.

According to the present invention, a graphitization degree (G) of the negative electrode material meets the following condition:

82≤graphitization degree≤95, preferably 84≤graphitization degree≤91, and more preferably, 85≤graphitization degree≤90.

In the present invention, the graphitization degree G of the negative electrode material is calculated according to the following formula:

G=(0.344−d₀₀₂)/(0.344−0.3354), wherein the door is calculated by a Bragg equation.

According to the present invention, a specific surface area (BET) of the negative electrode material is 0.1 m²/g to10 m²/g, preferably 0.5 m²/g to 5 m²/g, and more preferably 1 m²/g to 3 m²/g.

In the present invention, the specific surface area of the negative electrode material is measured by a nitrogen adsorption specific surface area method.

According to the present invention, the negative electrode material includes first phase carbon of coal-based graphite and second phase carbon of amorphous carbon;
part or all of a surface of the first phase carbon is covered with the second phase carbon;
or, the second phase carbon is dispersed to the first phase carbon.

According to the present invention, a mass ratio of the first phase carbon to the second phase carbon is 2 to 99:1 based on a total weight of the negative electrode material.

In the present invention, contents of the first phase carbon and the second phase carbon in the negative electrode material are calculated according to the amount of raw materials fed and a residual carbon rate.

Further preferably, the mass ratio of the first phase carbon to the second phase carbon is 4 to 70:1 based on the total weight of the negative electrode material.

A second aspect of the present invention provides a preparation method of a negative electrode material, wherein the method includes the following steps of:
(1) crushing coal to obtain coal particles;
(2) graphitizing the coal particles to obtain a graphitized material;
(3) mixing the graphitized material with a modifier to obtain a mixed material;
(4) pre-oxidizing the mixed material in air atmosphere to obtain a pre-oxidized sample; and
(5) carbonizing the pre-oxidized sample in an inert atmosphere to obtain the negative electrode material.

According to the present invention, in the process of preparing the negative electrode material, the modifier is mixed with the graphitized material obtained by graphitizing the coal, and then subjected to pre-oxidizing and carbonizing in sequence, so that the pore volume of the negative electrode material can be significantly reduced, and the compactness of the negative electrode material can be improved, so that the continuous high-rate cycle performance of a lithium ion battery containing the negative electrode material can be significantly improved.

Further, the coal is used as the raw material in the present invention, and when the negative electrode material is prepared by the method above, not only can a preparation cost of the negative electrode material be significantly reduced, but also high value-added utilization and clean and efficient conversion of the coal can be realized.

According to the present invention, the coal meets the following conditions: a vitrinite reflectance greater than or equal to 2; a volatile constituent less than or equal to 10 wt %; and an ash content less than or equal to 15 wt %.

In the present invention, when the coal meeting the above conditions is selected as the raw material for preparing the negative electrode material, the negative electrode material with moderate crystallinity, small crystal particle size and compact structure can be obtained, such that a lithium ion battery including the negative electrode material has high charge-discharge capacity, high initial coulombic efficiency and excellent continuous high-rate cycle performance.

In the present invention, the vitrinite reflectance of the coal is measured by the method in the national standard GB/T 6948, and the volatile constituent content and the ash content of the coal are both measured by the method in the national standard GB/T 30732.

According to the present invention, the coal meets the following conditions: a vitrinite reflectance greater than or equal to 2.3; a volatile constituent less than or equal to 10 wt %; and an ash content less than or equal to 6 wt %.

In the present invention, a conventional device in the art, such as a jet mill, a mechanical mill, a Raymond mill, and the like may be used to crush the coal.

In the present invention, in step (1), a particle size D₅₀ of the coal particles is 1 μm to 100 μm, preferably 2 μm to 50 μm.

In the present invention, the particle size D₅₀ of the coal particles is measured by a laser particle size analyzer.

According to the present invention, in step (2), the graphitizing condition includes: a carbonizing temperature of 2900° C. and above, and a carbonizing time of 0.5 hour to 100 hours.

According to the present invention, the graphitizing condition includes: a carbonizing temperature of 3000° ° C. to 3500° C., and a graphitizing time of 1 hour to 80 hours.

According to the present invention, the modifier is a precursor of amorphous carbon.

Further, the modifier is selected from asphalt and/or resin.

In the present invention, the asphalt may be selected from at least one of coal asphalt, petroleum asphalt, mesophase asphalt and oxidized asphalt.

In the present invention, when the modifier is asphalt, the modifier meets the following conditions: a softening point of the modifier is greater than or equal to 50° C., and a viscosity of the modifier at 400° C. is less than or equal to 1000 Pa·s.

In the present invention, the graphitized material obtained in step (2) is modified by using the modifier with specific softening point and viscosity, and the modifier may enter pore channels of the graphitized material obtained by coal graphitization, so that the pore volume in the prepared negative electrode material is significantly reduced; meanwhile, the graphitized material obtained by coal graphitization is surface-modified, so that the specific surface area is significantly reduced, and the structural compactness of the product is improved, so that the lithium ion battery containing the negative electrode material has higher initial coulombic efficiency and more excellent continuous high-rate cycle performance.

Further, the softening point of the modifier is greater than or equal to 150° C., preferably 200° ° C. to 360ºC. The viscosity of the modifier at 400° C. is less than or equal to 100 Pa's; preferably less than or equal to 20 Pa·s.

According to the present invention, a dosage ratio of the graphitized material to the modifier is 1 to 99.9:1.

In the present invention, when the amount of the graphitized material and the modifier used meet the above range, the prepared negative electrode material can have an optimal ratio, so that the obtained negative electrode material has excellent comprehensive performance. Specifically, if the amount of the modifier used is too high, the obtained second phase carbon is aggregated due to the existence of the excessive modifier, thereby reducing the charge-discharge capacity and the initial coulombic efficiency. However, if the amount of the modifier used is too small, surface modification of the modifier on the graphitized material is insufficient, which will eventually reduce the initial coulombic efficiency and the continuous high-rate cycle performance of the negative electrode material.

Further, a ratio of the amount of graphitized material used to the amount of modifier used is 4 to 99:1, preferably 6 to 99:1, and more preferably 8 to 99:1.

According to the present invention, in step (3), the pre-oxidizing condition includes: a pre-oxidizing temperature of 50° ° C. to 600° C. and a pre-oxidizing time of 1 hour to 100 hours.

In the present invention, the mixed material is pre-oxidized under the above conditions, so that the structural compactness of the second phase carbon can be significantly improved, and the second phase carbon with compact structure can be better filled in the pores of the first phase carbon, and the surface of the first phase carbon can be decorated, and finally the structural compactness of the prepared negative electrode material is significantly improved, so that the continuous high-rate cycle performance of the battery containing the negative electrode material can be significantly improved on the premise of maintaining high charge-discharge capacity, initial coulombic efficiency and rate capability.

Further preferably, the pre-oxidizing temperature is 100° C. to 550° C., and more preferably 200° ° C. to 500° C. The pre-oxidizing time is 3 hours to 80 hours.

According to the present invention, the carbonizing condition includes: a carbonizing temperature of 800° ° C. to 1,500° C. and a carbonizing time is 0.1 hour to 100 hours.

In the present invention, the pre-oxidized sample is carbonized under the above conditions, so that volatiles in the pre-oxidized sample can be removed while carbon is rearranged under the condition of fully retaining active components, and the compactness of the product is improved, so that the comprehensive performance of the prepared negative electrode material is more excellent.

Further preferably, the carbonizing temperature is 900° C. to 1400° ° C., and more preferably 1000° C. to 1300° C. The carbonizing time is 0.5 hour to 80 hours, more preferably, 1 hour to 50 hours.

A third aspect of the present invention provides a negative electrode material prepared by the preparation method above.

A fourth aspect of the present invention provides a negative electrode plate, wherein the negative electrode plate includes the negative electrode material above.

In the present invention, the negative electrode plate further includes a conductive agent and a binder. The amounts of the negative electrode material, the conductive agent and binder used may refer to conventional amounts of them that have been used in the art. Specifically, a ratio of the amount of negative electrode material used to the amount of conductive agent used and the amount of binder used is 80 to 98:1 to 10:1 to 10.

As for types of the conductive agent and the binder, conventional conductive agents and binders in the art may be used.

In the present invention, the negative electrode plate may be prepared according to the conventional method in the art. Specifically, the negative electrode material, conductive carbon black Super P, binder poly(vinylidene fluoride) (PVDF) and thickener CMC are evenly mixed according to the proportions, added with deionized water, and prepared into a uniform negative electrode slurry by a slurry mixer, and a solid content is controlled at 40 wt % to 50 wt %. The negative electrode slurry is evenly coated on a copper foil with a coater, dried and cut into pieces to obtain the negative electrode plates.

According to the present invention, when a compaction density of the negative electrode plate is 1.4 g/cm³ to 1.6 g/cm³, OI of the negative electrode plate is less than or equal to 15.

In the present invention, the OI value of the negative electrode plate refers to a ratio of a peak intensity 1004 of (004) crystal face to a peak intensity 1110 of (110) crystal face, which are obtained by XRD, of the negative electrode plate.

In the present invention, the negative electrode plate has a low OI value, indicating that the negative electrode plate has excellent orientation and high isotropy, thereby enabling a battery including the negative electrode plate to have excellent electrochemical performance.

Further, when the OI value of the negative electrode material is 0.1 to 15, preferably 1 to 10, a lithium ion battery including the negative electrode plate has high charge-discharge capacity and initial coulombic efficiency, and has excellent continuous high-rate cycle performance.

A fourth aspect of the present invention further provides an application of the above-mentioned negative electrode material or negative electrode plate in a lithium ion battery.

In the present invention, the lithium ion battery including the above-mentioned negative electrode material or negative electrode plate has excellent electrochemical performance. Specifically, the lithium ion battery including the above-mentioned negative electrode material has a charge-discharge capacity greater than or equal to 330 mAh/g, an initial coulombic efficiency greater than or equal to 92%, and a capacity retention rate of continuous high-rate cycling for 1,500 times at 5 C greater than or equal to 80%.

The present invention is described in detail hereinafter with reference to the embodiments.

### (1) XRD Analysis

Interplanar spacing d₀₀₂, Lₐ, L_{c} of the negative electrode material and OI value of the negative electrode plate were all tested and analyzed by a D8 Advance type X-ray diffractometer of Bruker AXS GmbH. Calibration was carried out by silicon internal standard method, the door value was calculated by Bragg equation, and Lₐ and L_{c} were calculated by Scherrer equation.

### (2) Graphitization Degree G

The graphitization degree G of the negative electrode material was calculated according to the following formula:

G=(0.344−d₀₀₂)/(0.344−0.3354), wherein the door was calculated by Bragg equation.

### (3) BET and Hole Volume

The BET and the hole volume of the negative electrode material were measured by 3flex N2 adsorption-desorption instrument of MICROMERITICS. Test method was carried out according to the national standard, and sample pretreatment was carried out at a temperature of 350° C. for 6 hours.

### (4) Particle Size

D₅₀ of coal was obtained by a Malvern Mastersizer 2000 laser particle size meter of Malvern Instruments Ltd.

(5) A vitrinite reflectance of coal was measured by the method in the national standard GB/T 6948, and a volatile constituent content and an ash content of the coal were both measured by the method in the national standard GB/T 30732.
(6) Softening point of modifier: a softening point of asphalt was tested by using Mettler titration.
(7) Viscosity of modifier: tested by MARS40 rotary rheometer of Germany Hake at a test temperature of 400° C. and a shear rate of 10/s.

### (8) Battery Performance

a. The charge-discharge capacity and the initial coulombic efficiency of the battery were subjected to charge-discharge tests through a CT2001A battery tester of a battery test system of Wuhan Land Electronics Co., Ltd at a current of 0.1 C (1 C=350 mAh/g) and a voltage of 0 V to 3 V.
b. The continuous high-rate cycle performance at 5 C was subjected to charge-discharge tests through Neware battery tester under test conditions as follows: at room temperature, charging to 4.2 V from a constant current of 5 C to a constant voltage, a cut-off current being 0.05 C, and discharging to 2.5 V at a constant current of 5 C.

### Example 1

(1) Coal (vitrinite reflectance of 2.445; volatile content of 7.7 wt %; and ash content of 2.6 wt %) was crushed by a mechanical mill to obtain coal particles with D₅₀ of 10 μm;
(2) the coal particles were graphitized at 3,000° ° C. for 25 hours to obtain a graphitized material;
(3) 93 parts of the graphitized material above were mixed with 7 parts of petroleum asphalt (a softening point of 240° C., and a viscosity of 8.553 Pa's at 400° C.) to obtain a mixed material, and a mass ratio of the graphitized material to modifier petroleum asphalt was 13.3:1;
(4) the mixed material was pre-oxidized at 300° C. for 20 hours in an air atmosphere to obtain a pre-oxidized sample; and
(5) the pre-oxidized sample was carbonized at 1,200° C. in an inert gas for 5 hours; and sieved to obtain a negative electrode material A1.

### Example 2

(1) Coal (vitrinite reflectance of 2.445; volatile content of 7.7 wt %; and ash content of 2.6 wt %) was crushed by a mechanical mill to obtain coal particles with D₅₀ of 10 μm;
(2) the coal particles were graphitized at 3000° ° C. for 25 hours to obtain a graphitized material;
(3) 85 parts of the graphitized material above were mixed with 15 parts of petroleum asphalt (a softening point of 240° ° C., and a viscosity of 8.553 Pa's at 400° C.) to obtain a mixed material, and a mass ratio of the graphitized material to modifier petroleum asphalt was 5.7:1;
(4) the mixed material was pre-oxidized at 300° C. for 20 hours in an air atmosphere to obtain a pre-oxidized sample; and
(5) the pre-oxidized sample was carbonized at 1,200° C. in an inert gas for 5 hours; and was sieved to obtain a negative electrode material A2.

### Example 3

A negative electrode material A3 was prepared according to the method of Example 1, except that the amount of the graphitized material used was 97 parts, the amount of the modifier used was 3 parts, and the mass ratio of the two was 32.3:1. The negative electrode material A3 was prepared.

### Example 4

A negative electrode material A4 was prepared according to the method of Example 1, except that the amount of the graphitized material used was 70 parts, the amount of the modifier used was 30 parts, and the mass ratio of the two was 2.3:1. The negative electrode material A4 was prepared.

### Example 5

A negative electrode material A5 was prepared according to the method of Example 1, except that mesophase asphalt with a softening point of 260° C. and a viscosity of 0.557 Pa's at 400° ° C. was used instead of the petroleum asphalt with a softening point of 240° C. and a viscosity of 8.553 Pa's at 400° C. The negative electrode material A5 was prepared.

### Example 6

A negative electrode material A6 was prepared according to the method of Example 1, except that oxidized asphalt with a softening point of 280° C. and a viscosity of 10.580 Pas at 400° C. was used instead of the petroleum asphalt with a softening point of 240° C. and a viscosity of 8.553 Pa's at 400° C. The negative electrode material A6 was prepared.

### Example 7

A negative electrode material A7 was prepared according to the method of Example 1, except that a composite modifier was used to replace the petroleum asphalt with a softening point of 240° C. and a viscosity of 8.553 mPa's at 400° C.; wherein, the composite modifier was a mixture of mesophase asphalt (a softening point of 260° C. and a viscosity of 0.557 mPa's at 400° C.) and oxidized asphalt (a softening point of 280° C. and a viscosity of 10.580 mPa's at 400° C.) in a mass ratio of 4:3. The negative electrode material A7 was prepared.

### Example 8

A negative electrode material A8 was prepared according to the method of Example 1, except that the pre-oxidizing was carried out at a temperature of 180ºC for 4 hours. The negative electrode material A8 was prepared.

### Example 9

A negative electrode material A9 was prepared according to the method of Example 1, except that the pre-oxidizing was carried out at a temperature of 400° C. for 10 hours. The negative electrode material A9 was prepared.

### Example 10

A negative electrode material A10 was prepared according to the method of Example 1, except that sucrose was used instead of the petroleum asphalt in the embodiment. The negative electrode material A10 was prepared.

### Comparative Example 1

A negative electrode material was prepared according to the method of Example 1, except that step (3), step (4) and step (5) were not performed, and a negative electrode material D1 was prepared. The negative electrode material D1 was homogeneous, and did not contain second phase carbon.

### Comparative Example 2

A negative electrode material was prepared according to the method of Example 1, except that the pre-oxidizing step of step (4) was not performed. A negative electrode material D2 was prepared.

### Comparative Example 3

A negative electrode material was prepared according to the method of Example 1, except that coal and petroleum asphalt were directly mixed to obtain a mixture, and the mixture was graphitized according to the graphitizing step of Example 1 to prepare a negative electrode material D3. In the negative electrode material D3, the petroleum asphalt was completely graphitized, and the negative electrode material D3 did not contain second phase amorphous carbon.

### Comparative Example 4

A negative electrode material was prepared according to the method of Example 1, except that petroleum asphalt was not contained in step (3). A negative electrode material D₄ was prepared. The negative electrode material D4 was homogeneous, and did not contain second phase carbon.

The negative electrode materials prepared in the examples and the comparative examples were characterized, and the results can be seen in Table 1 below.

TABLE 1

| | BET | V1 | V2 | | L_{c} | Lₐ | | OI | d₀₀₂ | |
|---|---|---|---|---|---|---|---|---|---|---|
| Sample | m²/g | cm³/g | cm³/g | ID/IG | nm | nm | G | value | nm | M1/M2 |
| A1 | 1.48 | 0.002618 | 0.002003 | 0.399 | 37.6 | 68.7 | 88.4 | 3.5 | 0.33640 | 24.6 |
| A2 | 2.26 | 0.003667 | 0.003035 | 0.423 | 36.2 | 69.9 | 87.6 | 4.0 | 0.33647 | 10.5 |
| A3 | 2.75 | 0.004515 | 0.003261 | 0.359 | 35.4 | 55.0 | 88.1 | 5.4 | 0.33642 | 59.9 |
| A4 | 3.73 | 0.007640 | 0.005910 | 0.819 | 29.6 | 76.2 | 85.4 | 3.2 | 0.33666 | 4.3 |
| A5 | 1.58 | 0.002184 | 0.001500 | 0.348 | 36.5 | 74.4 | 89.2 | 3.6 | 0.33633 | 20.8 |
| A6 | 1.81 | 0.002262 | 0.001821 | 0.349 | 37.6 | 68.7 | 88.6 | 3.5 | 0.33638 | 22.5 |
| A7 | 1.78 | 0.000206 | 0.000102 | 0.406 | 37.6 | 68.7 | 89.4 | 3.4 | 0.33631 | 21.5 |
| A8 | 2.91 | 0.006732 | 0.004581 | 0.464 | 35.4 | 67.1 | 87.8 | 3.8 | 0.33645 | 24.6 |
| A9 | 2.66 | 0.003952 | 0.002736 | 0.406 | 38.1 | 71.4 | 87.2 | 3.9 | 0.33650 | 24.6 |
| A10 | 4.12 | 0.007961 | 0.005200 | 0.497 | 32.2 | 61.8 | 86.2 | 7.6 | 0.33659 | 33.2 |
| D1 | 3.57 | 0.011620 | 0.008810 | 0.102 | 40.4 | 79.9 | 90.3 | 12.4 | 0.33623 | — |
| D2 | 3.32 | 0.008789 | 0.005001 | 0.349 | 37.6 | 68.7 | 87.7 | 10.2 | 0.33646 | 26.6 |
| D3 | 2.81 | 0.007501 | 0.005678 | 0.099 | 32.1 | 69.3 | 91.6 | 12.9 | 0.33612 | — |
| D4 | 3.42 | 0.010126 | 0.007866 | 0.101 | 38.6 | 81.8 | 90.4 | 13.1 | 0.33623 | — |

V1 refers to the total pore volume of the negative electrode material; V2 refers to the volume of the mesopores of the negative electrode material; M1 refers to a quality of the first phase carbon in the negative electrode material; M2 refers to a quality of the second phase carbon in the negative electrode material; and OI value refers to an OI value when a compaction density is 1.55 g/cm³.

### Test Example

### (1) Half Cell Performance Test:

The negative electrode materials prepared in the examples and the comparative examples were evenly mixed with conductive carbon black Super P and binder poly(vinylidene fluoride) (PVDF) in a mass ratio of 92:3:5, and then added with a solvent N-methylpyrrolidone (NMP), stirred into uniform negative electrode slurry, which was evenly coated on a copper foil with a scraper, dried to obtain a negative electrode plate, cut into pieces, and then transferred to an MBraun 2000 glove box (Ar atmosphere, H₂O and O₂ concentration being less than 0.1×10⁻⁶ vol %), and then assembled into a button battery by using a metal lithium plate as a reference electrode. Charge-discharge capacity and initial coulombic efficiency of the button battery were tested, and the test results were shown in Table 2.

### (2) Total Cell Performance Test:

The negative electrode materials prepared in the examples and the comparative examples were evenly mixed with conductive carbon black Super P, binder poly(vinylidene fluoride) (PVDF) and thickener CMC in a mass ratio of 94:2:3:1, added with dionized water, and uniform negative electrode slurry was obtained by a slurry mixer, and a solid content was controlled at 40 wt % to 50 wt %. The negative electrode slurry was evenly coated on a copper foil with a coater, dried and cut into pieces to obtain the negative electrode plates. The negative electrode plates were matched with a ternary positive material NCM523, added with electrolyte and separator and assembled into pouch batteries. The pouch batteries were tested for continuous high-rate cycle life at 5 C. The cycle process was as follows: charging to 4.2 V from a constant current of 5 C to a constant voltage, a cut-off current being 0.05 C, and discharging to 2.5 V at a constant current of 5 C, and repeating the process sequentially. A capacity retention rate of discharge capacity/initial discharge capacity after cycling for 1,500 times was calculated as the capacity retention rate of continuous high-rate cycling for 1,500 times at 5 C. The test results can be seen in Table 2.

TABLE 2

| | Half cell | | Total cell |
|---|---|---|---|
| | Charge | Initial | Capacity retention |
| | capacity | coulombic | rate of continuous |
| | at 0.1 C | efficiency | high-rate cycling for |
| Embodiment | mAh/g | % | 1,500 times at 5 C % |
| A1 | 346 | 94.1 | 84.6 |
| A2 | 340 | 93.2 | 89.3 |
| A3 | 348 | 94.1 | 83.3 |
| A4 | 332 | 92.7 | 80.7 |
| A5 | 350 | 94.2 | 84.9 |
| A6 | 347 | 94.1 | 84.7 |
| A7 | 349 | 93.9 | 85.6 |
| A8 | 343 | 93.7 | 83.2 |
| A9 | 344 | 93.8 | 83.8 |
| A10 | 340 | 92.9 | 79.4 |
| D1 | 346 | 93.9 | 60.6 |
| D2 | 340 | 93.1 | 80.3 |
| D3 | 351 | 94.7 | 66.5 |
| D4 | 347 | 94.0 | 61.9 |

It can be seen from the results of Table 1 and Table 2 that the negative electrode material prepared by the examples of the present invention has the features of compact structure and small crystal particle size, while the continuous high-rate cycle performance of the battery containing the negative electrode material can be significantly improved under the premise of keeping higher charge-discharge capacity, initial coulombic efficiency and rate capability.

Those described above are merely preferred embodiments of the present invention, but are not intended to limit the present invention. Within the scope of the technical concept of the present invention, many simple modifications can be made to the technical solutions of the present invention, comprising the combination of various technical features in any other suitable way. These simple modifications and combinations shall also be regarded as the contents disclosed by the present invention and belong to the protection scope of the present invention.

1. A negative electrode material, wherein the negative electrode material has the following features:
(1) a total pore volume of the negative electrode material is less than or equal to 0.02 cm³/g, and a volume of mesopores having a pore diameter of 2 nm to 50 nm is 0.00001 cm³/g to 0.02 cm³/g; and
(2) a height ratio of a D peak to a G peak, obtained by Raman spectroscopy, of the negative electrode material meets the following condition: 0.20≤ID/IG≤1.

2. The negative electrode material according to claim 1, wherein the total pore volume of the negative electrode material is 0.0001 cm³/g to 0.01 cm³/g, and the volume of the mesopores having the pore diameter of 2 nm to 50 nm is 0.00001 cm³/g to 0.01 cm³/g; and
preferably, the total pore volume of the negative electrode material is 0.0002 cm³/g to 0.007 cm³/g, and the volume of the mesopores having the pore diameter of 2 nm to 50 nm is 0.0001 cm³/g to 0.007 cm³/g.

3. The negative electrode material according to claim 1, wherein the height ratio of the D peak to the G peak, obtained by Raman spectroscopy, of the negative electrode material meets the following conditions: 0.25≤ID/IG≤0.9, and more preferably, 0.3≤ID/IG≤0.8.

4. The negative electrode material according to claim 1, wherein interplanar spacing d₀₀₂ of (002) crystal plane, obtained by powder XRD, of the negative electrode material, meets the following condition: 0.3340 nm≤d_{002≤0.3400} nm, preferably, 0.3350 nm≤d_{002≤0.3390} nm, and more preferably, 0.3364 nm≤d_{002≤0.3370} nm;
preferably, a crystal size L_{c} in a c-axis direction, obtained by powder XRD, of the negative electrode material, meets the following condition: 25 nm≤L_{c}≤70 nm, preferably 28 nm≤L_{c}≤60 nm, and more preferably, 30 nm≤L_{c}≤50 nm; and
preferably, a crystal size Lₐ in an a-axis direction, obtained by XRD, of the negative electrode material, meets the following condition: 40 nm≤Lₐ≤150 nm, preferably 45 nm≤Lₐ≤120 nm, and more preferably 50 nm≤Lₐ≤100 nm.

5. The negative electrode material according to claim 1, wherein a graphitization degree of the negative electrode material meets the following condition:
82≤graphitization degree≤95, preferably 84≤graphitization degree≤91, and more preferably, 85≤graphitization degree≤90.

6. The negative electrode material according to claim 1, wherein a specific surface area of the negative electrode material is 0.1 m²/g to 10 m²/g, preferably 0.5 m²/g to 5 m²/g, and more preferably 1 m²/g to 3 m²/g.

7. The negative electrode material according to claim 1, wherein the negative electrode material comprises first phase carbon of coal-based graphite and second phase carbon of amorphous carbon;
part or all of a surface of the first phase carbon is covered with the second phase carbon;
or, the second phase carbon is dispersed to the first phase carbon.

8. The negative electrode material according to claim 7, wherein a mass ratio of the first phase carbon to the second phase carbon is 2 to 99:1 based on a total weight of the negative electrode material; and
preferably, the mass ratio of the first phase carbon to the second phase carbon is 4 to 70:1 based on the total weight of the negative electrode material.

9. A preparation method of a negative electrode material, wherein the method comprises the following steps of:
(1) crushing coal to obtain coal particles;
(2) graphitizing the coal particles to obtain a graphitized material;
(3) mixing the graphitized material with a modifier to obtain a mixed material;
(4) pre-oxidizing the mixed material in air atmosphere to obtain a pre-oxidized sample; and
(5) carbonizing the pre-oxidized sample in an inert atmosphere to obtain the negative electrode material.

10. The method according to claim 9, wherein the coal meets the following conditions: a vitrinite reflectance greater than or equal to 2; a volatile constituent content less than or equal to 10 wt %; and an ash content less than or equal to 15 wt %; and
preferably, the coal meets the following conditions: a vitrinite reflectance greater than or equal to 2.3; a volatile constituent content less than or equal to 10 wt %; and an ash content less than or equal to 6 wt %.

11. The method according to claim 9, wherein in step (2), the graphitizing condition comprises: a carbonizing temperature of 2900° C. and above, and a carbonizing time of 0.5 hour to 100 hours; and
preferably, the graphitizing condition comprises: a carbonizing temperature of 3000° C. to 3500° C., and a graphitizing time of 1 hour to 80 hours.

12. The method according to claim 9, wherein the modifier is a precursor of amorphous carbon;
preferably, the modifier is selected from asphalt and/or resin;
more preferably, when the modifier is asphalt, the modifier meets the following conditions: a softening point of the modifier is greater than or equal to 50° ° C., preferably greater than or equal to 150° ° C., and more preferably 200° ° C. to 360° C.; and a viscosity of the modifier at 400° C. is less than or equal to 1000 Pa·s, preferably less than or equal to 100 Pa·s; and more preferably, less than or equal to 20 Pa·s; and
preferably, a dosage of the amount of graphitized material used to the amount of modifier used is 1 to 99.9:1, preferably 4 to 99:1.

13. The method according to claim 9, wherein in step (3), the pre-oxidizing condition comprises: a pre-oxidizing temperature of 50° ° C. to 600° C., preferably 100° C. to 550° C., and more preferably 200° C. to 500° C.; and
preferably, a pre-oxidizing time is 1 hour to 100 hours, preferably, 3 hours to 80 hours.

14. The method according to claim 9, wherein in step (5), the carbonizing condition comprises: a carbonizing temperature of 800° C. to 1,500° C., preferably 900 to 1,400° ° C., and more preferably 1,000° C. to 1,300° C.; and
preferably, a carbonizing time is 0.1 hour to 100 hours, preferably 0.5 hour to 80 hours, and more preferably 1 hour to 50 hours.

15. A negative electrode material prepared by the preparation method according to claim 9.

16. A negative electrode plate, wherein the negative electrode plate comprises the negative electrode material according to claim 1.

17. The negative electrode plate according to claim 16, wherein when a compaction density of the negative electrode plate is 1.4 g/cm³ to 1.6 g/cm³, OI of the negative electrode plate is less than or equal to 15, preferably 0.1 to 15, and more preferably 1 to 10.

18. A lithium ion battery, comprising the negative electrode material according to claim 1.
